(19) United States
(12) Patent Application Publication
(10) Pub. No.: US 2019/0314853 A1
(43) Pub. Date: Oct. 17, 2019

(54) APPLICATOR FOR COATING SURFACES

(71) Applicant: Robert Hugh SHAW, Belwood (CA)

(72) Inventor: Robert Hugh SHAW, Belwood (CA)

(21) Appl. No.: 16/387,450

(22) Filed: Apr. 17, 2019

Related U.S. Application Data
(60) Provisional application No. 62/658,676, filed on Apr. 17, 2018.

(51) Int. Cl. B05C 11/04; B05D 1/40

(52) U.S. Cl. CPC B05C 11/044; B05C 11/045; B05D 1/40

(57) ABSTRACT

An re-usable applicator for coating surfaces with curable liquids has a holder having a receptacle for removably supporting a blade, a blade sized and shaped to securely fit within the receptacle, the blade having a base made from a first material and a tip made from a second material, the base and tip being bonded together, and a retainer to fix a position of the blade within the receptacle. The tip has a lower edge having a W-shaped cross-section that provides two edges to level a liquid that is coated onto a surface. A post extends at an upward and outward angle from the holder and a flange extends upward and outward from the receptacle at the same angle as the post. The post has two opposing slots extending upward from a bottom edge thereof, wherein the slots are sized to slide onto the flange.

### TECHNICAL FIELD

The present disclosure relates to the field of applicators used to coat surfaces with curable liquids.

### BACKGROUND

Curable liquids (for example, but not limited to, epoxies, silicones and urethane resins) harden after a brief period of time. Many prior art devices for applying a uniform coating to a surface (for example, a floor) are not reusable after the epoxy hardens, and/or they do not result in a uniform coating, and/or they are too complex and/or constructed inefficiently and/or cannot be used in an efficient manner. In this regard, many prior art applicators must be disposed of after each use because the cured epoxy covers various parts of the applicator making the applicator inoperable.

### SUMMARY OF PARTICULAR EMBODIMENTS

It will be appreciated by those skilled in the art that other variations of the embodiments described below may also be practiced without departing from the scope of the invention. Further note, these embodiments, and other embodiments of the present invention will become more fully apparent from a review of the description and claims which follow.

In one embodiment, the present disclosure relates to an applicator for coating surfaces with curable liquids comprising a holder having a receptacle or removably supporting a blade; a blade sized and shaped to fit within the receptacle, the blade having a base made from a first material and a tip made from a second material, the base and tip being bonded together; and a handle extending from the holder.

In one embodiment, the present disclosure relates to an applicator for coating a surface with a curable liquid, the applicator comprising a holder having a receptacle for removably supporting a blade; a blade sized and shaped to securely fit within the receptacle, the blade having a base made from a first material and a tip made from a second material, the base and tip being bonded together; the applicator having a retainer to fix a position of the blade within the receptacle; the blade being at least five inches in height from a lower edge to an upper edge; and the holder having a handle extending upward and outward therefrom.

In one embodiment, the present disclosure relates to a blade for use in coating surfaces with curable liquids, the blade comprising a base made from a first material and a tip made from a second material, the base and tip being bonded together, the blade having an anchor portion extending along the base.

In one embodiment, the present disclosure relates to a blade for use with an applicator for coating surfaces with curable liquids, the blade comprising a base made of a first material and a tip made of a second material, the base and tip being bonded together, the blade having the protrusion has a cross sectional shape corresponding to an interior shape of the applicator so that the blade can be removably and securely fixed within the applicator.

In one embodiment, the present disclosure relates to a method of using an applicator coating a surface with a curable liquid, the applicator comprising a holder having a receptacle for removably supporting a blade, a blade sized and shaped to securely fit within the receptacle, the blade having a base made from a first material and a tip made from a second material, the base and tip being bonded together, the applicator having a retainer to fix a position of the blade within the receptacle, the blade being at least five inches in height from a lower edge to an upper edge and the holder having a handle, the method comprising: commencing with the blade being separate from the receptacle, sliding the blade into the receptacle and reactivating the retainer to fix the blade in position in the receptacle; and using the applicator apply a curable coating to a surface to be coated, removing and replacing the blade in the receptacle with a replacement blade as the blade wears or has cured coating thereon to ensure that the coating is applied uniformly to the surface and disposing of each used blade that is removed until an application of the coating has been completed.

### BRIEF DESCRIPTION OF THE DRAWINGS

The embodiments herein will be understood from the following description with reference to the drawings, in which:

FIG. 1 is a side view of an applicator having a holder with a receptacle for removably supporting a blade in accordance with one embodiment of the present invention;

FIG. 2 is a front view of the applicator shown in FIG. 1;

FIG. 3 is a side view of the applicator shown in FIG. 1 with a blade removed;

FIG. 4 is a top view of an applicator shown in FIG. 1 with a handle removed;

FIG. 5 is a front view of a blade for the applicator shown in FIG. 1;

FIG. 6 is a side view of the blade shown in FIG. 5;

FIG. 7 is a partial perspective view of the blade shown in FIG. 5 showing a side and a contour of a lower edge;

FIG. 8 is a side view of the applicator without a blade in accordance with one embodiment of the present invention;

FIG. 9 is a perspective view of part of the applicator of FIG. 8;

FIG. 10 is a perspective view of a cylindrical pole in accordance with one embodiment of the present invention;

FIG. 11 is a perspective view of a generally triangular bracket in accordance with one embodiment of the present invention;

FIG. 12 is a top view of the bracket of FIG. 11;

FIG. 13 is side view of a blade in accordance with one embodiment of the present invention;

FIG. 14 is a perspective view of the blade of FIG. 13; and

FIG. 15 is a front view of the blade of FIG. 13.

In the drawings, preferred embodiments of the invention are illustrated by way of example. It is to be expressly understood that the drawings are only for the purpose of illustration and as an aid to understanding, and are not intended as a definition of the limits of the invention.

### DETAILED DESCRIPTION OF A PREFERRED EMBODIMENT

In this respect, before explaining at least one embodiment of the invention in detail, it is to be understood that the invention is not limited in its application to the details of construction and the arrangements of the components outlined in the following description or illustrated in the drawings. The invention is capable of other embodiments and of being practiced and carried out in various ways. Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, the stated features and/or configurations or embodiments thereof the suggested intent may be applied as seen fit to certain operating conditions or environments by one experienced in the field of art.

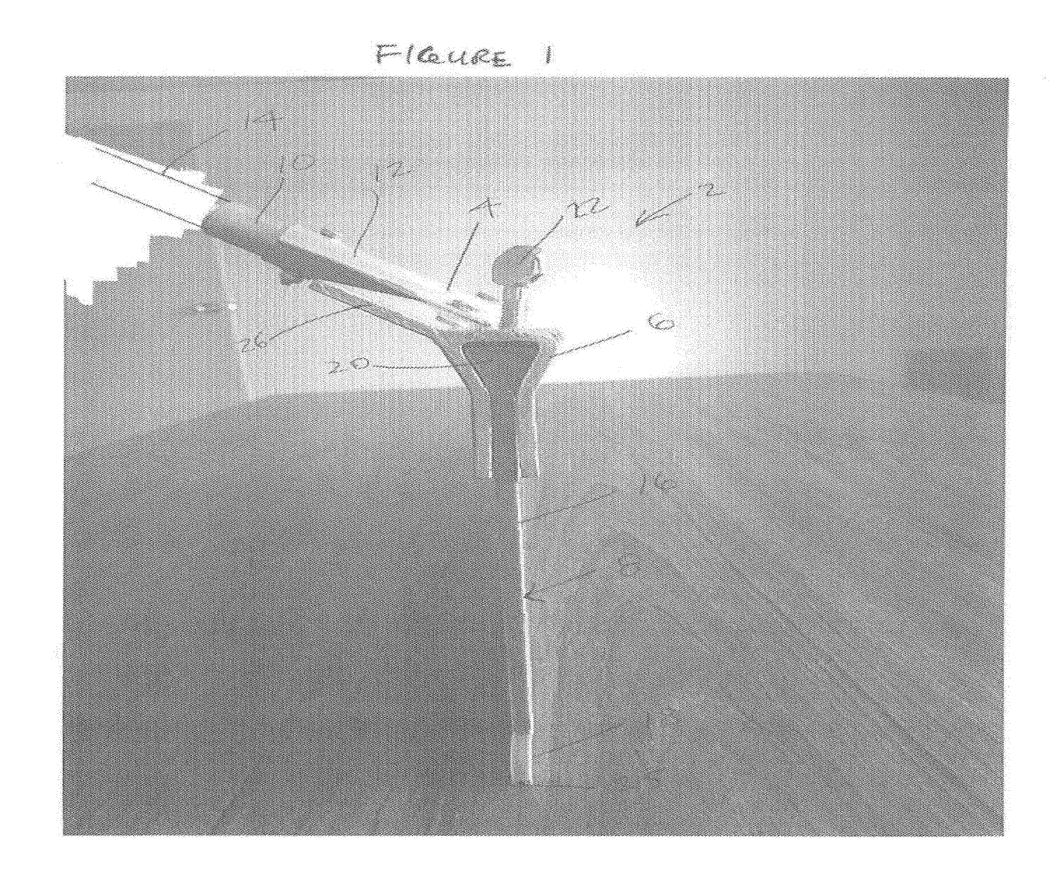

Referring to the drawings, in the embodiment shown in FIG. 1, an applicator 2 has a holder 4 with a receptacle 6 for receiving a blade 8. A cylindrical post 10 extends at an upward and outward angle from the holder 4. An outer bracket 12 supports the post 10. A handle 14 is mounted partially within the post 10. The blade 8 has a base 16 and a tip 18 that are made from different materials. The base 16 has an anchor portion 18 that is sized and shaped to removably fit within the receptacle 6. Preferably, the anchor portion 18 has a dovetail shaped cross-section to correspond to a shape of a portion of the receptacle 6 that receives the anchor portion. The dovetail shape facilitates efficient replacement of the blade 8 and releaseable securement of the blade 8 to the applicator 2. In the embodiment shown in FIG. 1, the receptacle 6 has a partial dovetail shape having a lower channel section of reduced width along the entirety of the channel and an upper section of a width greater than the width of the channel, the receptacle 6 shaped for disposing a lip between the upper section and the lower channel section of the receptacle 6, the lip for preventing downward movement of the blade in response to gravitational force or other downward forces. The channel section also prevents lateral movement of the blade 8.

In the embodiment shown, a set screw 22 is threaded into a threaded opening (not shown in FIG. 1) in an upper surface of the receptacle 60. The set screw is a retainer to fix the blade within the receptacle. When the set screw 22 is tightened against the anchor portion 18, the blade 8 is securely held within the receptacle 6.

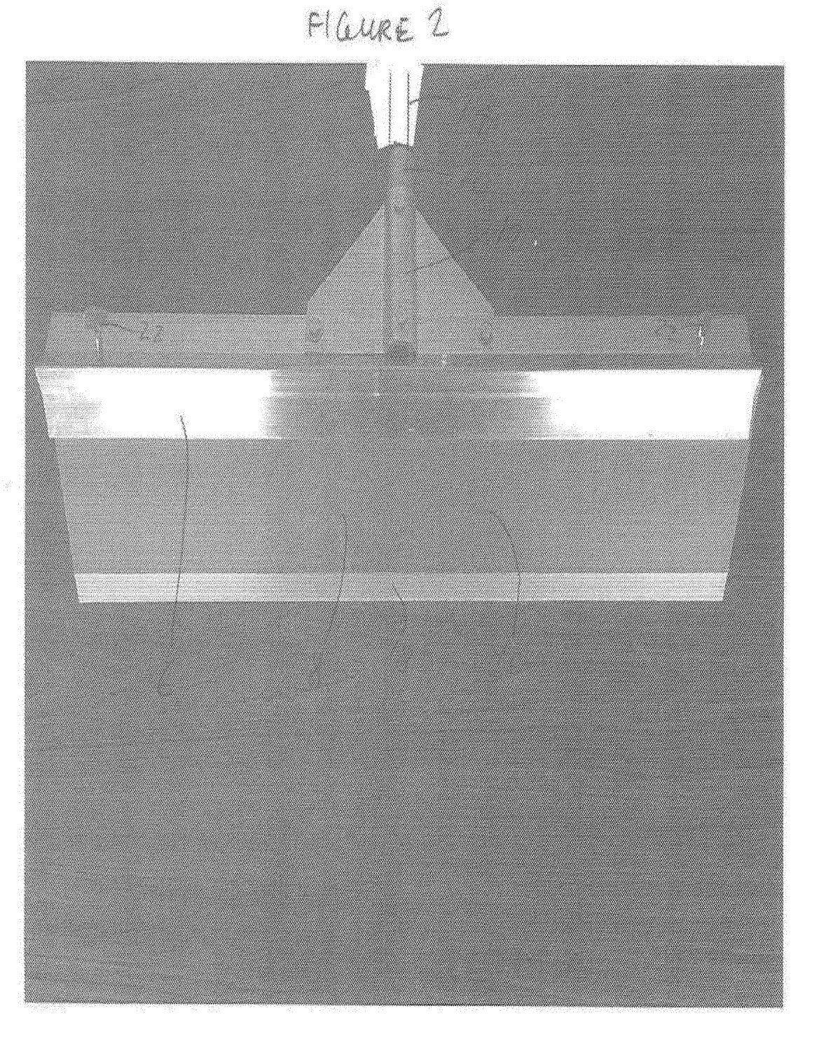

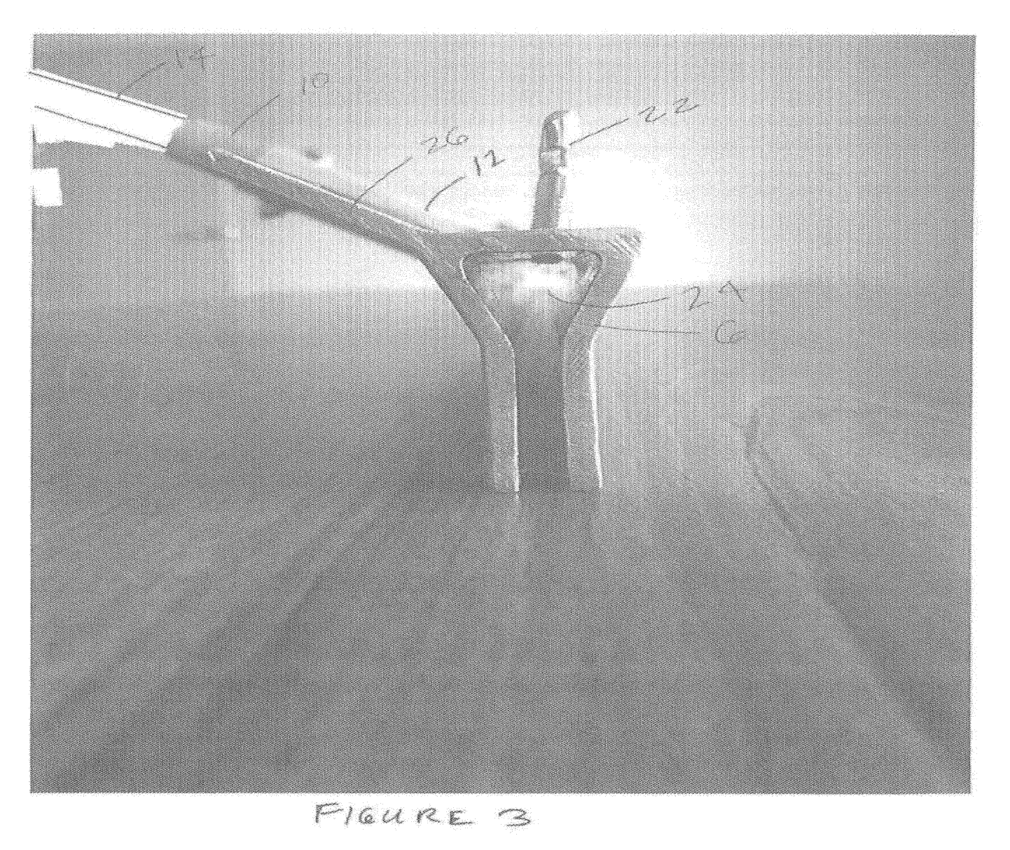

The same reference numerals are used in FIGS. 2, 3 and 4 to describe those components that are identical to the components shown in FIG. 1. In FIG. 3, it can be seen that the set screw 22 extends slightly into a cavity 24 of the receptacle 6.

There are two set screws 22 shown in FIGS. 2 and 4. Preferably, only one set screw is used to hold the blade within the receptacle. Whether one or a plurality of set screws are used, the location of the set screw along the width of the receptacle can vary.

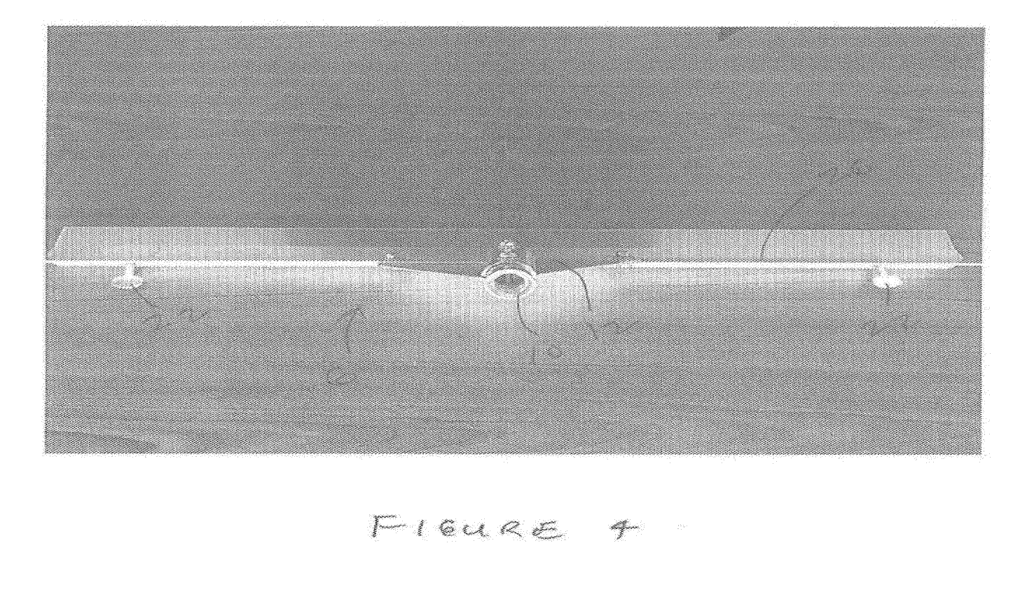

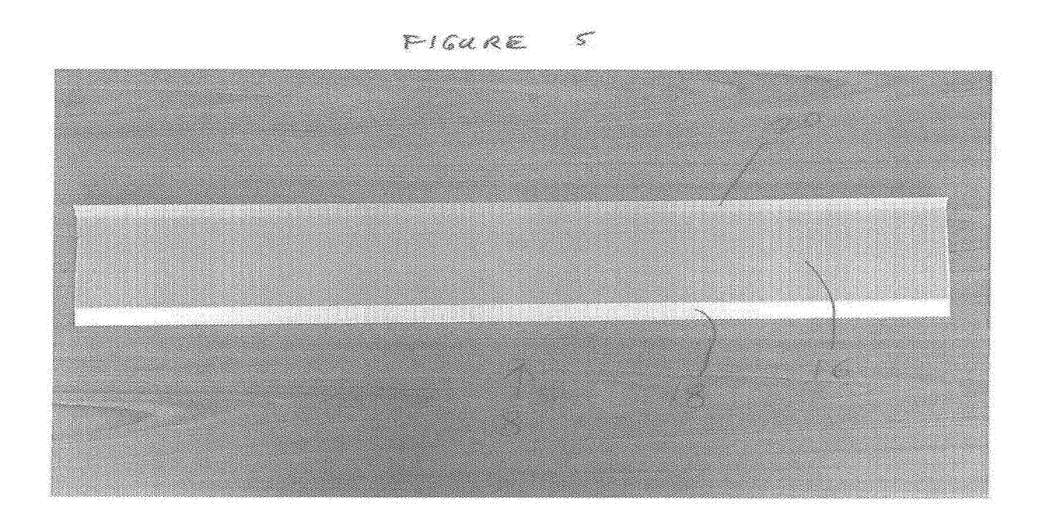

In FIGS. 5, 6 and 7, there are shown various views of the blade 8. The same reference numerals are used in FIG. 5 for those components of the blade 8 shown in FIGS. 1 to 4. The base 16 of the blade 8 is made from a first material and the tip 20 is made from a second material. The tip 20 is that portion of the blade 8 shown in FIGS. 5, 6 and 7 that has a lighter shade than the base 16.

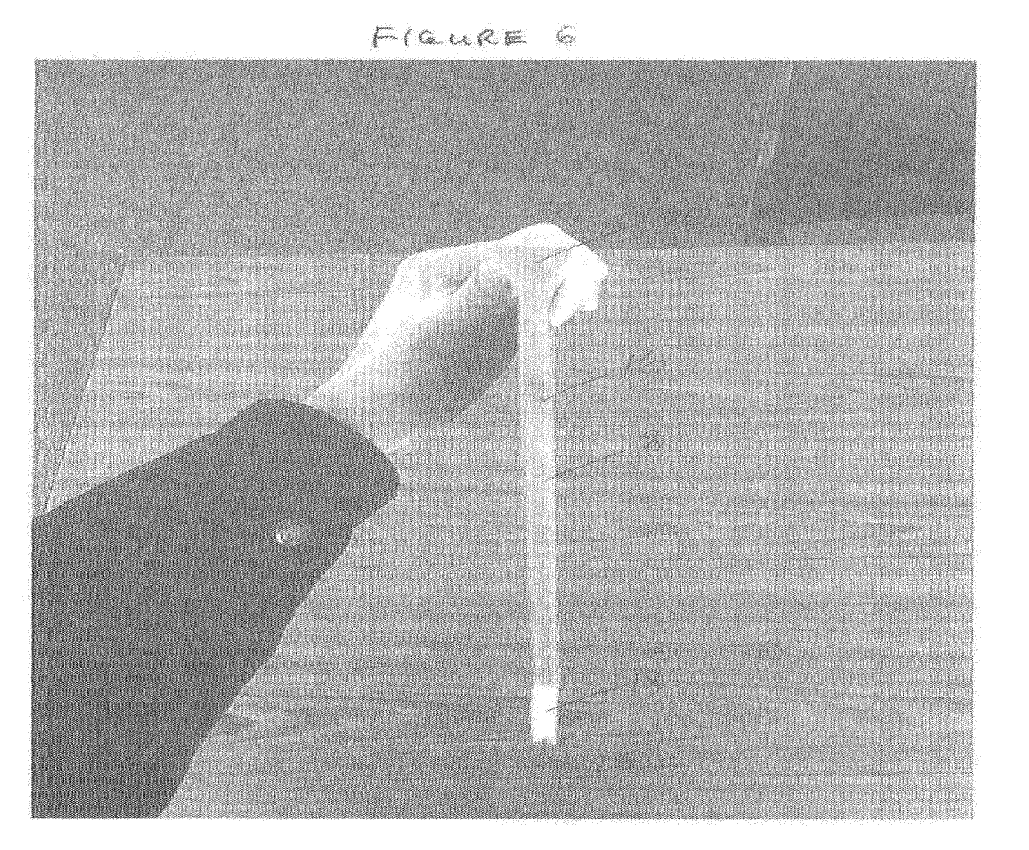

In FIG. 7, it can be seen that the tip 20 has a lower edge 24 that has a W-shaped cross-section that actually provides two edges to level a liquid (not shown) that is coated onto a surface (not shown). While the W-shaped cross-section for the lower edge 24 of the tip 20 is preferred, other shapes of the lower edge will also be suitable. In some designs, it is preferable to have a lower edge of the tip 20 that has a series of notches extending through the lower edge from front to rear. In FIGS. 1 to 4, it can be seen that the holder 4 has a flange 26 that extends upward and outward from the receptacle 6 at the same angle as the post 10.

Preferably, the base and tip of the blade are extruded simultaneously so that the tip and base are bonded to one another. Preferably, the base 16 is made from a PVC (polyvinylchloride) material and the tip 20 is made from a nitrile rubber material.

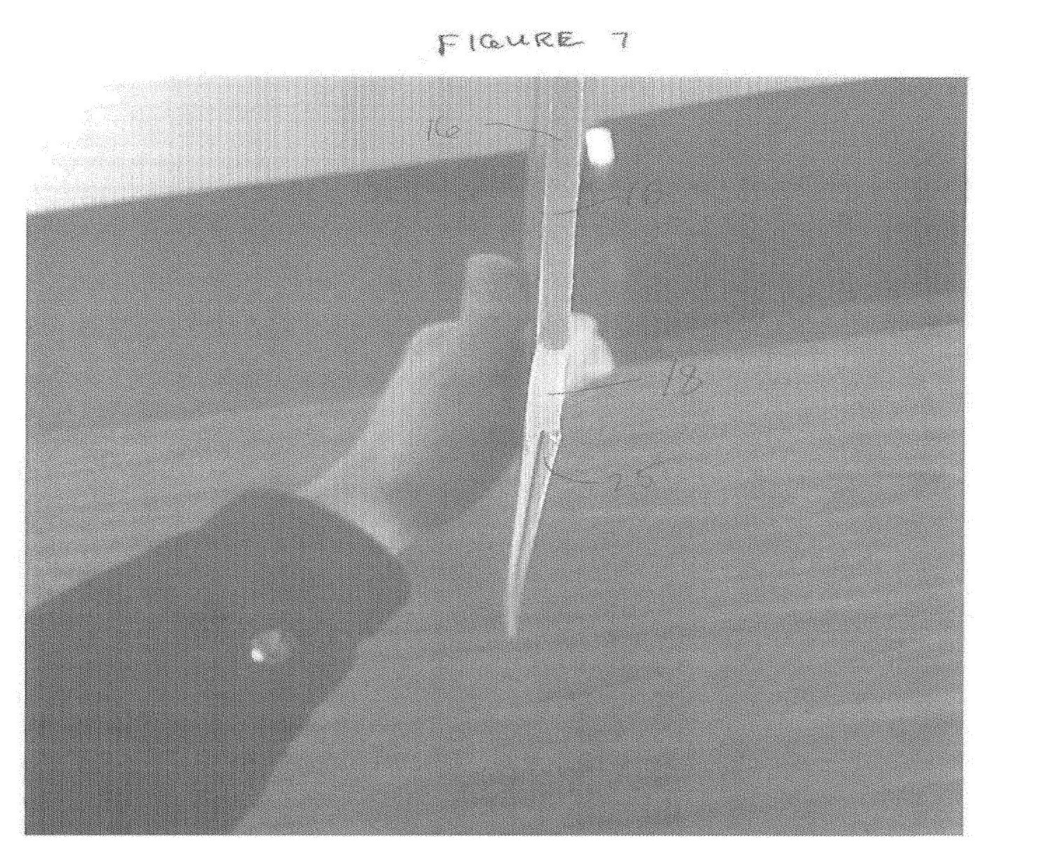

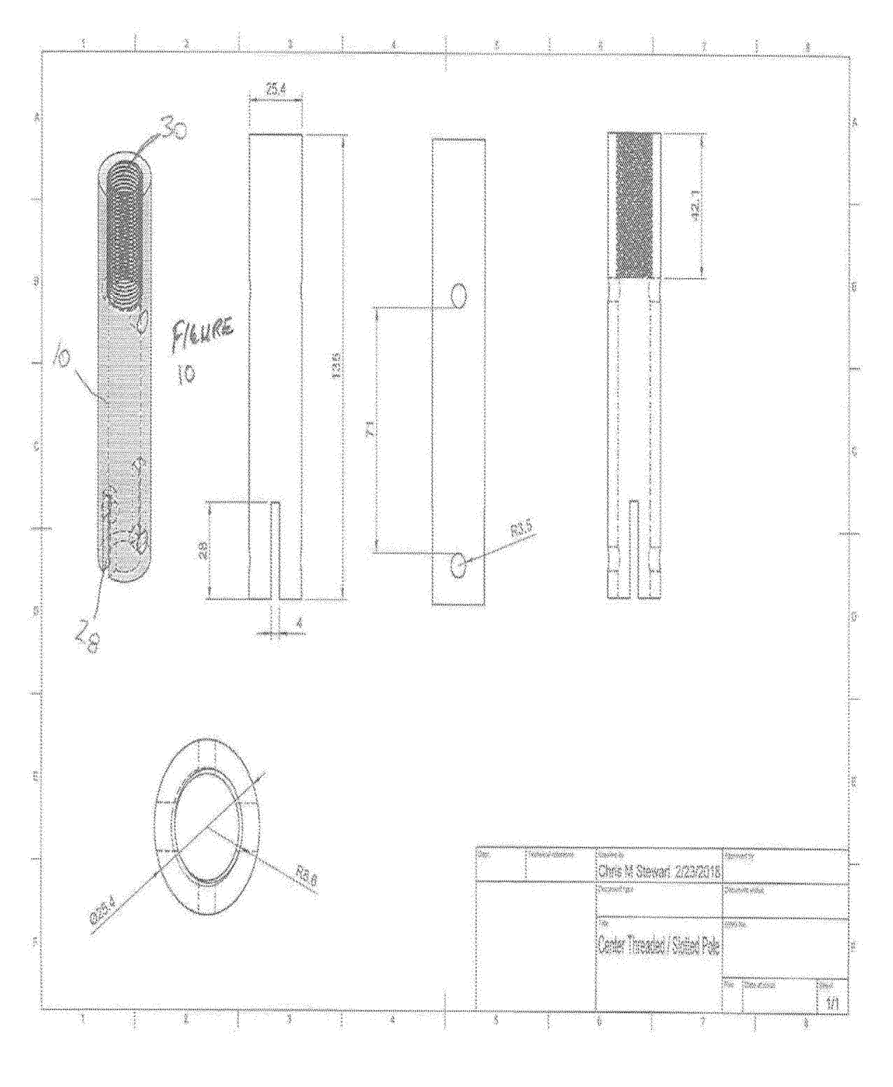

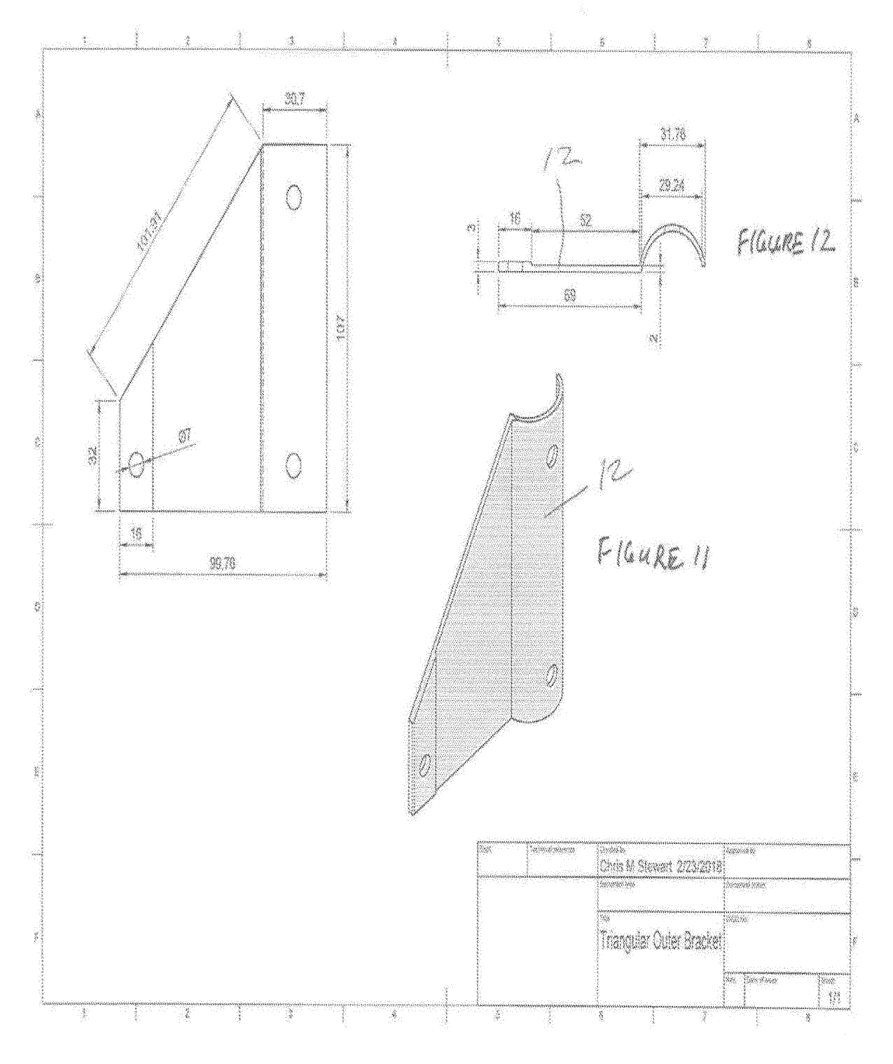

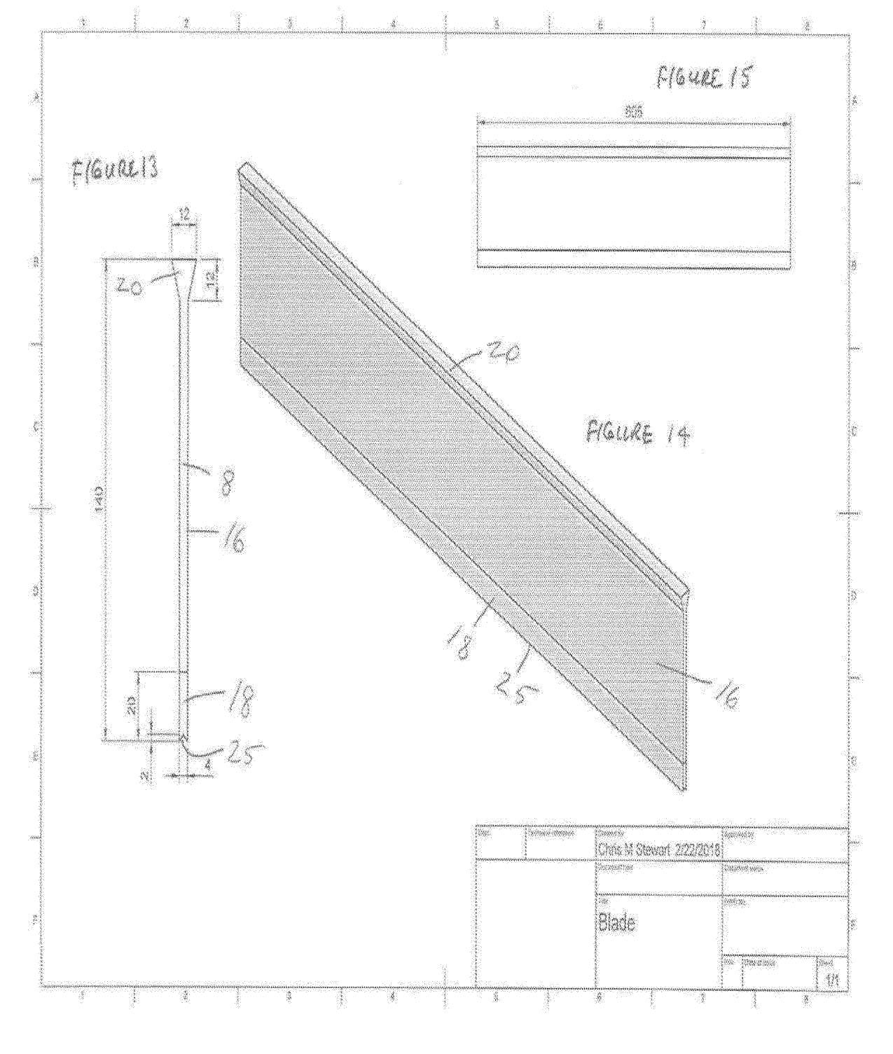

The same reference numerals are used in FIGS. 9 to 15 as those used in FIGS. 1 to 7 for those components of the holder 4 that are identical.

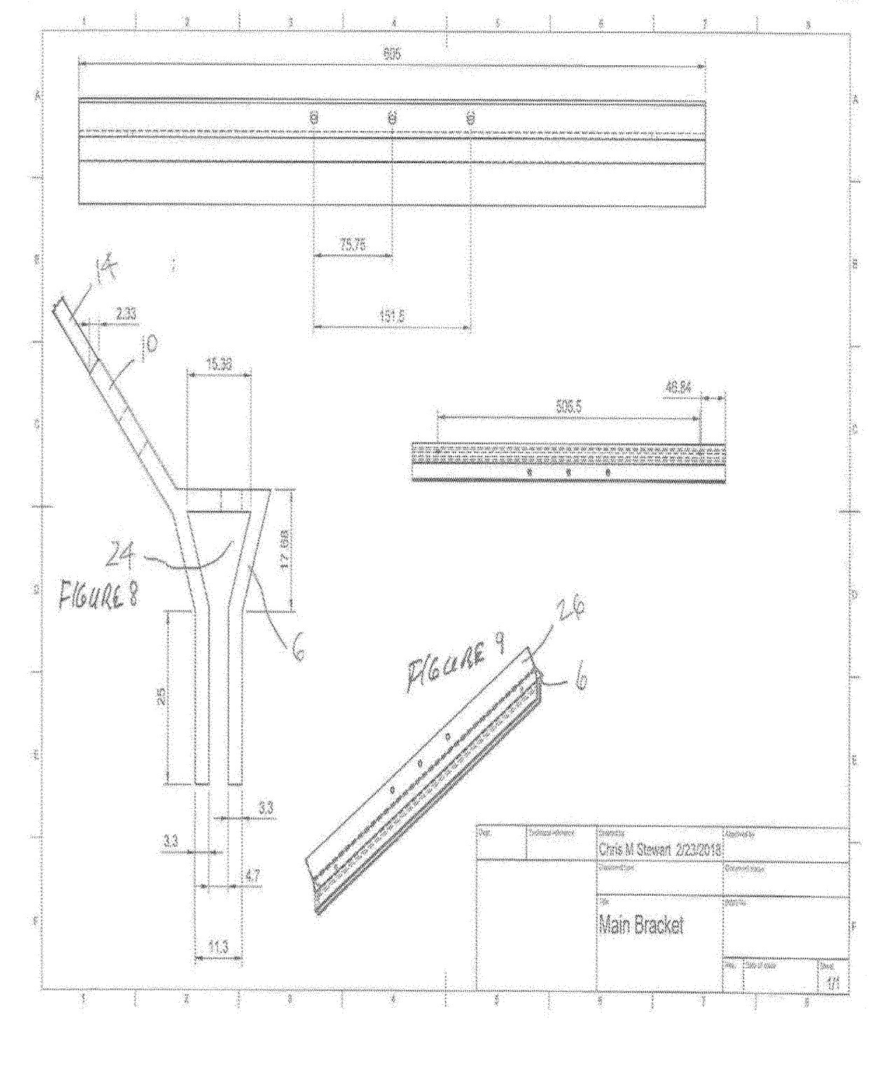

In FIG. 10, it can be seen that the post 10 has two opposing slots 28 extending upward from a bottom edge thereof. The slots 28 are sized to slide onto the flange 26. The post 10 has a screw thread 30 on an inner surface of an upper end thereof. The screw thread 30 is sized to receive a corresponding screw thread (not shown) on a lower end of the handle 14. The handle 14 is only partially shown in the drawings and is preferably long enough for a user to use the applicator to apply a liquid coating to a surface when the user is in a standing position. Preferably, the surface to which the coating is applied is horizontal or at least substantially horizontal.

The blade 8 has a height that is sufficiently high so that the liquid coating does not contact the holder or the set screw during use of the applicator. For example, in a preferred embodiment, the height of the blade is at least five inches. When epoxy is used as the liquid being applied, if the epoxy comes in contact with the set screw or gets inside a housing 32 of the receptacle 6, it will be impossible to remove the set screw to allow the blade to be removed and replaced unless the epoxy can be dissolved by immersing the holder in an appropriate solvent.

The holder 4 and the blade 8 are preferably made from materials that will not be damaged if the applicator and blade are inserted into a solvent to dissolve any cured epoxy after the applicator has been used, should that be necessary. The applicator is designed to keep the epoxy or other coating away from the holder 4 during normal usage. When a blade becomes worn or when a job has been completed, the blade can be disposed of and replaced with a new blade so that the holder can be used repeatedly for several jobs without requiring replacement.

Preferably, the second material from which the tip of the blade is made is a softer material than the first material from which the blade is made. Blades that have a series of notches extending from front to rear through the tip are used to apply coatings that are thicker than those being applied by a blade that does not have the plurality of notches. With the present invention, the blade can be easily removed and replaced with a new blade as required. Preferably, the holder is made from an alloy material that is not harmed by placing the holder into a solvent to dissolve any cured epoxy thereon. If a solvent must be used, that adds further expense and is also time-consuming. The applicator of the present invention is designed so that a solvent will not have to be used and there will be little, if any, cured epoxy on the holder. The cured epoxy will preferably only be on the blade, which is disposable.

For coating a surface that extends up to a vertical wall, the blade can be adjusted within the holder to extend beyond a side of the holder where the wall is located so that the blade will contact the wall as the surface is being coated, but the holder will not be in contact with the wall.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

What is claimed is:

1. An applicator for coating a surface with a curable liquid, the applicator comprising:
a. a holder having a receptacle for removably supporting a blade;
b. a blade sized and shaped to securely fit within the receptacle, the blade having a base made from a first material and a tip made from a second material, the base and tip being bonded together; and
c. a retainer to fix a position of the blade within the receptacle.

2. The applicator as claimed in claim 1 wherein the base and tip are bonded together by extruding the base and tip simultaneously.

3. The applicator as claimed in claim 1, wherein the blade is at least five inches in height from a lower edge to an upper edge.

4. The applicator as claimed in claim 1, further comprising a holder having a handle extending upward and outward therefrom.

5. The applicator as claimed in claim 1 wherein one of the receptacle and the blade has a protrusion and another of the receptacle and the blade has a corresponding indentation, the protrusion and the blade being located so that the protrusion is located in the blade when the blade is located in the receptacle.

6. The applicator as claimed in claim 1 where the blade is at least six inches in height.

7. The applicator as claimed in claim 1 wherein the blade is adjustable and/or removable and replaceable within the holder by releasing the retainer to remove or adjust the blade and reactivating the retainer to hold the blade in a fixed position within the receptacle.

8. A blade for use with an applicator for coating surfaces with curable liquids, the blade comprising a base made of a first material and a tip made of a second material, the base and tip being bonded together, the blade having the protrusion has a cross sectional shape corresponding to an interior shape of the applicator so that the blade can be removably and securely fixed within the applicator.

9. The blade as claimed in claim 8 where the protrusion has a dovetail cross sectional shape.

10. A method of using an applicator coating a surface with a curable liquid, the applicator comprising a holder having a receptacle for removably supporting a blade, a blade sized and shaped to securely fit within the receptacle, the blade having a base made from a first material and a tip made from a second material, the base and tip being bonded together, the applicator having a retainer to fix a position of the blade within the receptacle, the blade being at least five inches in height from a lower edge to an upper edge and the holder having a handle, the method comprising:
i. commencing with the blade being separate from the receptacle, sliding the blade into the receptacle and reactivating the retainer to fix the blade in position in the receptacle; and
ii. using the applicator apply a curable coating to a surface to be coated, removing and replacing the blade in the receptacle with a replacement blade as the blade wears or has cured coating thereon to ensure that the coating is applied uniformly to the surface and disposing of each used blade that is removed until an application of the coating has been completed.

11. The applicator as claimed in claim 1, wherein the tip has a lower edge that has a W-shaped cross-section for providing two edges to level a liquid coated onto a surface.

12. The applicator as claimed in claim 1, further comprising a post extending at an upward and outward angle from the holder.

13. The applicator as claimed in claim 12, further comprising a flange that extends upward and outward from the receptacle at the same angle as the post.

14. The applicator as claimed in claim 13, wherein the post has two opposing slots extending upward from a bottom edge thereof, wherein the slots are sized to slide onto the flange.

15. The applicator as claimed in claim 1, wherein the base has an anchor portion having a dovetail shaped cross-section corresponding to the shape of a portion of the receptacle that receives the anchor portion.

16. The applicator as claimed in claim 1, wherein the receptacle has a partial dovetail shape having a lower channel section of reduced width along the entirety of the channel and an upper section of a width greater than the width of the channel, the receptacle shaped for creating a lip between the upper section and the lower channel section of the receptacle, the lip for preventing downward movement of the blade.
